(19) United States
(12) Patent Application Publication
(10) Pub. No.: US 2023/0305424 A1
(43) Pub. Date: Sep. 28, 2023

(54) PRINT HEAD AND IMAGE FORMING DEVICE

(71) Applicant: Toshiba Tec Kabushiki Kaisha, Tokyo (JP)

(72) Inventor: Kazumasa TAKADA, Numazu Shizuoka (JP)

(73) Assignee: Toshiba Tec Kabushiki Kaisha, Tokyo (JP)

(21) Appl. No.: 17/700,799

(22) Filed: Mar. 22, 2022

(51) Int. Cl. G03G 15/043

(52) U.S. Cl. CPC G03G 15/043

(57) ABSTRACT

A print head includes a first memory, a second memory, and a plurality of light emitting elements. The first memory stores a first light amount correction data set for causing the plurality of light emitting elements to emit light with a first light amount, and stores a first difference data set showing a difference between a second light amount correction data set for causing the plurality of light emitting elements to emit light with a second light amount and the first light amount correction data set. The second memory stores the first light amount correction data set, or the second light amount correction data set obtained from the first light amount correction data set and the first difference data set. The plurality of light emitting elements emit light based on the first or second light amount correction data set stored in the second memory.

### FIELD

Embodiments described herein relate generally to a print head and an image forming device.

### BACKGROUND

An electrophotographic image forming device includes a print head, and the print head includes a plurality of light emitting elements of a light emitting diode (LED) or an organic light emitting diode (OLED), and a stretched lens array (SLA) that collects light from the plurality of light emitting elements on a photosensitive drum. Each light emitting element corresponds to one pixel, and an arrangement of the plurality of light emitting elements is a main scanning direction, and a direction orthogonal to the main scanning direction is a sub scanning direction. For example, when the image forming device has 1200 dpi, 15400 light emitting elements are arranged in one or more lines. The image forming device exposes the photosensitive drum with light emitted from the plurality of light emitting elements, and prints, on a recording paper, an image corresponding to a latent image formed on the photosensitive drum.

During manufacturing of the print head, a light amount correction device measures light amount and resolution (MTF) of each element and calculates a light amount correction data set. The light amount correction device writes the calculated light amount correction data set to a non-volatile memory of the print head. The light emitting element of the print head emits light based on the light amount correction data set written in the non-volatile memory. The print head emits the light based on the light amount correction data set to maintain image quality.

An optimum value of the light amount correction data set varies depending on a distance (D) between the print head and the photosensitive drum. In an image forming device having a structure in which a distance between a print head and a photosensitive drum changes (for example, approaches) depending on a life, a plurality of correction values according to the distance are required to be stored in a memory. In this case, a capacity of the memory is required to increase, which leads to an increase in cost.

### DESCRIPTION OF THE DRAWINGS

FIG. 1 is a schematic cross-sectional view illustrating an example of an image forming device according to at least one embodiment;

FIG. 2 is a block diagram illustrating an example of a control system;

FIG. 3 is a top view illustrating an example of a print head;

FIG. 4 is a side view illustrating an example of the print head;

FIG. 5 is a bottom view illustrating an example of the print head;

FIG. 6 is an enlarged view illustrating an example of a part of the print head;

FIG. 7 is a side view illustrating a positional relation between the print head and a photoconductor;

FIG. 8 is a diagram illustrating an example of the print head and a correction data interface unit;

FIG. 9 is a diagram illustrating an example of print head information PHDI stored in the print head;

FIG. 10 is a diagram illustrating an example of print head information PHI;

FIG. 11 is a diagram illustrating an outline of a MTF;

FIG. 12 is a diagram illustrating a relation between the MTF and a distance (D); and

FIG. 13 is a diagram illustrating a relation between the MTF and a streak image.

### DETAILED DESCRIPTION

In general, according to at least one embodiment, a print head includes a first memory, a second memory, and a plurality of light emitting elements. The first memory stores a first light amount correction data set for causing the plurality of light emitting elements to emit light with a first light amount, and stores a first difference data set showing a difference between a second light amount correction data set for causing the plurality of light emitting elements to emit light with a second light amount and the first light amount correction data set. The second memory stores the first light amount correction data set, or the second light amount correction data set obtained from the first light amount correction data set and the first difference data set. The plurality of light emitting elements emit light based on the first or second light amount correction data set stored in the second memory.

Hereinafter, an image forming device according to the embodiment will be described with reference to the drawings. In the following drawings used for description of the embodiment, a scale of each part is appropriately changed. In addition, in the following drawings used for the description of the embodiment, configurations are omitted as appropriate for the purpose of description.

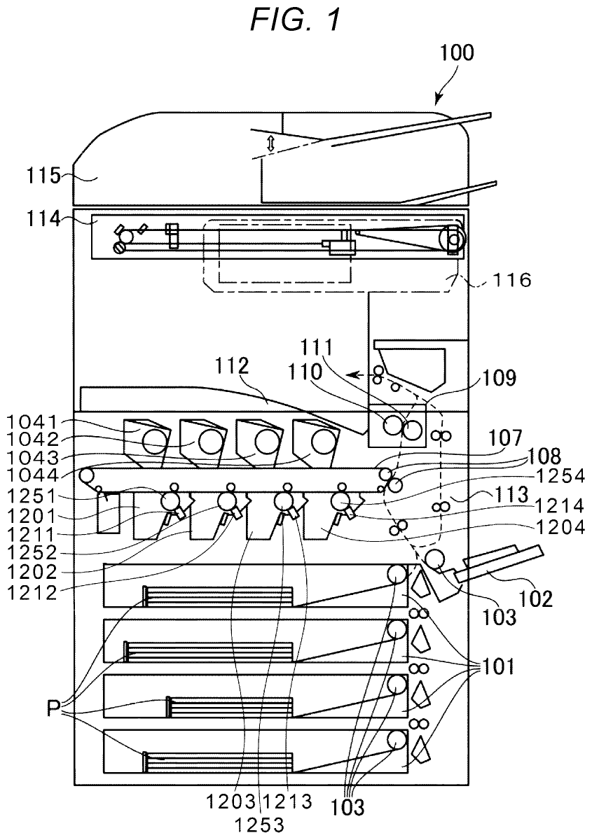

FIG. 1 is a schematic cross-sectional view illustrating an example of the image forming device according to at least one embodiment.

An image forming device 100 prints an image by an electrophotographic method. The image forming device 100 is, for example, a multifunction peripheral (MFP), a copier, a printer, or a facsimile. As illustrated in FIG. 1, the image forming device 100 includes, for example, paper feed trays 101, a manual feed tray 102, paper feed rollers 103, toner cartridges 1041, 1042, 1043, 1044, a transfer belt 107, transfer rollers 108, a fixing unit 109, a heating unit 110, a pressure roller 111, a paper discharge tray 112, a duplex unit 113, an image reading unit 114, a document feeder 115, a control panel 116, image forming units 1201, 1202, 1203, 1204, print heads 1211, 1212, 1213, 1214, and photoconductors 1251, 1252, 1253, 1254.

The toner cartridges 1041, 1042, 1043, 1044 are collectively referred to as toner cartridges 104. The image forming units 1201, 1202, 1203, 1204 are collectively referred to as image forming units 120. The print heads 1211, 1212, 1213, 1214 are collectively referred to as print heads 121. The photoreceptors 1251, 1252, 1253, 1254 are collectively referred to as photoconductors 125.

The image forming units 120 print an image by the electrophotographic method. That is, the image forming units 120 form the image on an image forming medium P or the like by using toners. The image forming medium P is, for example, a sheet-shaped paper. The image reading unit 114 reads an image from a document or the like on which the image is formed. For example, the image forming device 100 implements document copying by printing, on the image forming medium P using the image forming units 120, the image read from the document or the like by the image reading unit 114.

The paper feed tray 101 accommodates the image forming medium P used for printing.

The manual feed tray 102 is a table for manually feeding the image forming medium P.

The paper feed roller 103 rotates by an action of a motor to convey, from the paper feed tray 101, the image forming medium P accommodated in the paper feed tray 101 or the manual feed tray 102. The toner cartridges 104 store the toners to be supplied to the image forming units 120. At least one embodiment describes a case where the image forming device 100 includes the toner cartridge 1041, the toner cartridge 1042, the toner cartridge 1043, and the toner cartridge 1044. The toner cartridge 1041, the toner cartridge 1042, the toner cartridge 1043, and the toner cartridge 1044 store toners corresponding to cyan, magenta, yellow, and key (black) (CMYK) colors, respectively. Colors of the toners stored in the toner cartridges 104 are not limited to the CMYK colors, and may be any other color. The toners stored in the toner cartridges 104 may be special toners. For example, the toner cartridge 104 may store a decolorable toner that is decolorized and invisible at a temperature higher than a predetermined temperature.

The image forming unit 120 includes the print head 121, the photoconductor 125, and the like. The print head 121 includes one or more light emitting element lines. The light emitting element line includes a plurality of light emitting elements. The light emitting element is a LED or an organic EL. For example, if the image forming device 100 is a model corresponding to, for example, 1200 dpi, the print head 121 includes 15400 light emitting elements. An arrangement of the light emitting elements is a main scanning direction, and a direction orthogonal to the main scanning direction is a sub scanning direction.

The photoconductor 125 is uniformly charged by a charger. Each light emitting element of the print head 121 emits light based on image data. When the photoconductor 125 in a charged state is exposed to the light from the print head 121, potential of the exposed portion of the photoconductor 125 is lowered and an electrostatic latent image is formed on a surface of the photoconductor 125. The image forming unit 120 includes a developer, and the developer develops the electrostatic latent image on the surface of the photoconductor 125 using the toner supplied from the toner cartridge 104. Accordingly, a toner image is formed on the surface of the photoconductor 125. The image formed on the surface of the photoconductor 125 is transferred (primarily transferred) onto the transfer belt 107.

The image forming device 100 includes the image forming unit 1201, the image forming unit 1202, the image forming unit 1203, and the image forming unit 1204. The image forming unit 1201, the image forming unit 1202, the image forming unit 1203, and the image forming unit 1204 receive respectively supplies of the toners corresponding to the CMYK colors to form an image.

The image forming unit 1201 includes the print head 1211, the photoconductor 1251, and the like. The image forming unit 1202 includes the print head 1212, the photoconductor 1252, and the like. The image forming unit 1203 includes the print head 1213, the photoconductor 1253, and the like. The image forming unit 1204 includes the print head 1214, the photoconductor 1254, and the like.

The transfer belt 107 is, for example, an endless belt, and is rotatable by the action of the roller. The transfer belt 107 rotates to convey the image transferred from the image forming units to positions of the transfer rollers 108.

The transfer rollers 108 include two rollers facing each other. The transfer rollers 108 transfer (secondarily transfer) the image formed on the transfer belt 107 onto the image forming medium P passing between the rollers of the transfer rollers 108.

The fixing unit 109 heats and pressurizes the image forming medium P on which the image is transferred. Accordingly, the image transferred onto the image forming medium P is fixed. The fixing unit 109 includes the heating unit 110 and the pressure roller 111 facing each other.

The heating unit 110 is, for example, a roller provided with a heat source that heats the heating unit 110. The heat source is, for example, a heater. The roller heated by the heat source heats the image forming medium P.

Alternatively, the heating unit 110 may include an endless belt suspended from a plurality of rollers. For example, the heating unit 110 includes a plate-shaped heat source, an endless belt, a belt conveyance roller, a tension roller, and a press roller. The endless belt is, for example, a film-shaped member. The belt conveyance roller drives the endless belt. The tension roller applies tension to the endless belt. A surface of the press roller is formed with an elastic layer. By bringing a heating portion side into contact with an inner side of the endless belt and pressing the heating portion side toward the press roller, a fixing nip having a predetermined width is formed between the plate-shaped heat source and the press roller. Since the plate-shaped heat source performs heating while forming a nip region, responsiveness during energization is higher than that of a heating system using a halogen lamp.

In the endless belt, for example, a silicon rubber layer having a thickness of 200 μm is formed on an outer side of a steel use stainless (SUS) base material having a thickness of 50 μm or polyimide that is a heat-resistant resin having a thickness of 70 μm, and the outermost periphery is coated with a surface protective layer such as perfluoroalkoxy alkane (PFA). In the press roller, for example, a silicon sponge layer having a thickness of 5 mm is formed on a surface of an iron rod having a diameter of 10 mm, and the outermost periphery is coated with a surface protective layer such as PFA.

In the plate-shaped heat source, for example, a glaze layer and a heating resistance layer are laminated on a ceramic substrate. An aluminum heat sink is bonded to the plate-shaped heat source to release excessive heat to an opposite side and prevent warpage of the substrate. The heating resistance layer is formed of a known material such as TaSiO₂, and is divided into a predetermined number of parts having a predetermined length in the main scanning direction.

The pressure roller 111 applies pressure to the image forming medium P passing between the pressure roller 111 and the heating unit 110.

The paper discharge tray 112 is a table to which the image forming medium P on which printing is completed is discharged.

The duplex unit 113 brings the image forming medium P into a state in which printing on a back surface is possible. For example, the duplex unit 113 inverts surface and back surfaces of the image forming medium P by switching back the image forming medium P using a roller or the like.

The image reading unit 114 reads an image from a document. The image reading unit 114 is, for example, an optical reduction unit including an imaging element such as a charge-coupled device (CCD) image sensor. Alternatively, the image reading unit 114 may be a contact image sensor (CIS) unit including an imaging element such as a complementary metal-oxide-semiconductor (CMOS) image sensor. Alternatively, the image reading unit 114 is another known unit.

The document feeder 115 is also referred to as an auto document feeder (ADF), for example. The document feeder 115 sequentially conveys documents placed on a document tray. Images of the conveyed documents are read by the image reading unit 114. In addition, the document feeder 115 may include an image reading unit that reads images from a back surface of the documents.

The control panel 116 functions as a user interface, and includes buttons, a touch panel, and the like for an operator to operate the image forming device 100. The touch panel is, for example, a laminate of a display such as a liquid crystal display or an organic EL display and a pointing device based on a touch input. Therefore, the buttons and the touch panel function as an input device that receives an operation performed by the operator of the image forming device 100. The display of the touch panel functions as a display device that notifies the operator of the image forming device 100 of various types of information.

For example, the control panel 116 displays a light amount mode menu of a plurality of light amount modes, and sets a predetermined light amount mode selected from the light amount mode menu.

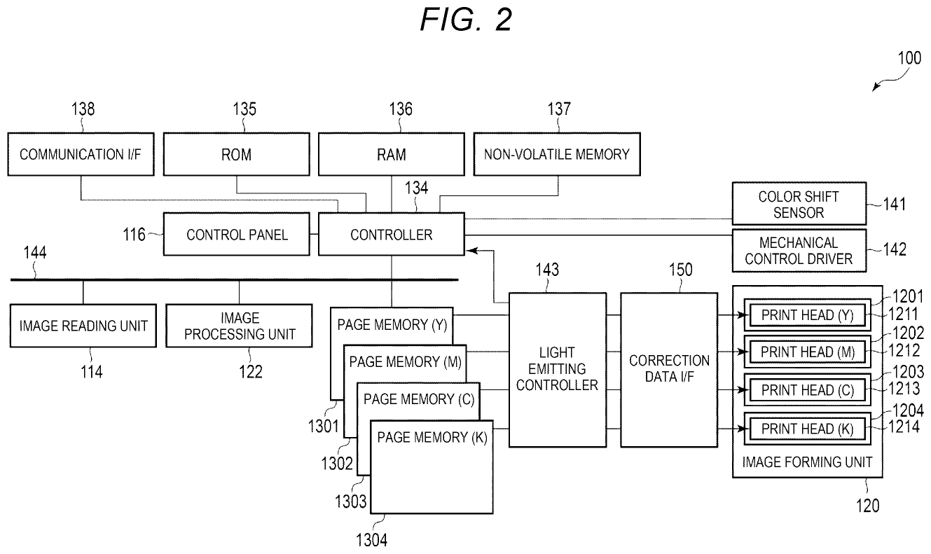

FIG. 2 is a block diagram illustrating an example of a control system of the image forming device according to the embodiment.

As illustrated in FIG. 2, the image forming device 100 includes the image reading unit 114, an image processing unit 122, the image forming unit 120, a controller 134, a read only memory (ROM) 135, a random access memory (RAM) 136, a non-volatile memory 137, a communication interface (I/F) 138, the control panel 116, page memories 1301, 1302, 1303, 1304, a light emitting controller 143, an image data bus 144, and a correction data interface (I/F) 150. Further, the image forming device 100 includes a color shift sensor 141 and a mechanical control driver 142. The image forming unit 120 include the image forming units 1201, 1202, 1203, and 1204.

The ROM 135, the RAM 136, the non-volatile memory 137, the communication I/F 138, the control panel 116, the color shift sensor 141, the mechanical control driver 142, and the light emitting controller 143 are connected to the controller 134.

The image reading unit 114, the image processing unit 122, the controller 134, and the page memories 1301, 1302, 1303, 1304 are connected to the image data bus 144. The page memories 1301, 1302, 1303, 1304 output image data 31 of Y, M, C, or K, respectively. The light emitting controller 143 is connected to the page memories 1301, 1302, 1303, 1304, and receives the image data 31 of Y from the page memory 1301, the image data 31 of M from the page memory 1302, the image data 31 of C from the page memory 1303, and the image data 31 of K from the page memory 1304. The print heads 1211, 1212, 1213, 1214 are connected to the light emitting controller 143. The light emitting controller 143 inputs the image data 31 of Y, M, C, or K to the print head 1211, 1212, 1213, or 1214.

The controller 134 includes one or more processors, and controls operations such as image reading, image processing, and image formation according to various programs stored in at least one of the ROM 135 and the non-volatile memory 137.

The controller 134 inputs image data of a test pattern to the page memories 1301, 1302, 1303, 1304, and forms the test pattern. The color shift sensor 141 detects the test pattern formed on the transfer belt 107, and outputs a detection signal to the controller 134. The controller 134 can recognize a positional relation of the test pattern of all the colors from an input of the color shift sensor 141. Further, the controller 134 selects the paper feed tray 101 that feeds the sheet on which the image is to be formed through the mechanical control driver 142.

The controller 134 instructs setting of the light amount correction data set corresponding to the predetermined light amount mode based on the predetermined light amount mode set by the control panel 116.

The ROM 135 stores various programs and the like necessary for controlling the controller 134. The various programs include a light emission control program of a print head. The light emission control program is a program for controlling timings of light emission and light-off (non-light emission) based on the image data.

The RAM 136 temporarily stores data required for the control of the controller 134. The non-volatile memory 137 stores a part or all of the various programs, various parameters, and the like.

The mechanical control driver 142 controls an operation of a motor and the like required for printing in accordance with an instruction from the controller 134. The communication I/F 138 outputs various information to an outside and inputs various information from the outside. For example, the communication I/F 138 acquires the image data including a plurality of image lines. The image forming device 100 prints, by a print function, the image data acquired via the communication I/F 138. The control panel 116 receives operation input from a user and a serviceman.

The image reading unit 114 optically reads an image of a document set on a document table, acquires the image data including the plurality of image lines, and outputs the image data to the image processing unit 122. The image processing unit 122 performs various types of image processing such as correction on the image data input via the communication I/F 138 or the image data from the image reading unit 114. The page memories 1301, 1302, 1303, 1304 store the image data processed by the image processing unit 122. The controller 134 edits the image data on the page memories 1301, 1302, 1303, 1304 to match printing positions or the print heads 121. The image forming unit 120 forms the image based on the image data stored in the page memories 1301, 1302, 1303, 1304. That is, the image forming unit 120 forms the image based on the light emission (light emission and light-off states) of each light emitting element according to the image data.

The light emitting controller 143 includes one or more processors, and controls the light emission of the light emitting element based on the image data according to the various programs stored in at least one of the ROM 135 and the non-volatile memory 137. That is, the light emitting controller 143 outputs a drive signal for causing a light emitting element LEE to emit the light to the light emitting element LEE at a predetermined timing.

The light emitting controller 143 instructs the setting of the light amount correction data set corresponding to the predetermined light amount mode based on the instruction from the controller 134.

The correction data interface 150 reads print head information PHDI from the print head 121 based on the instruction from the light emitting controller 143, and sets a predetermined light amount correction data set corresponding to the predetermined light amount mode to the print head 121. The correction data interface 150 will be described in detail later. The print head information PHDI includes the light amount correction data set and one or more light amount correction difference data sets. The print head information PHDI will be described in detail later.

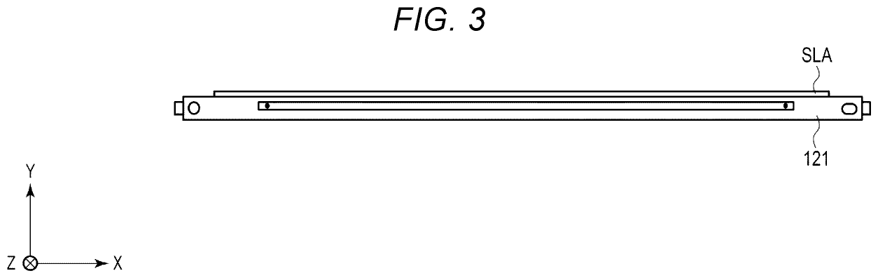

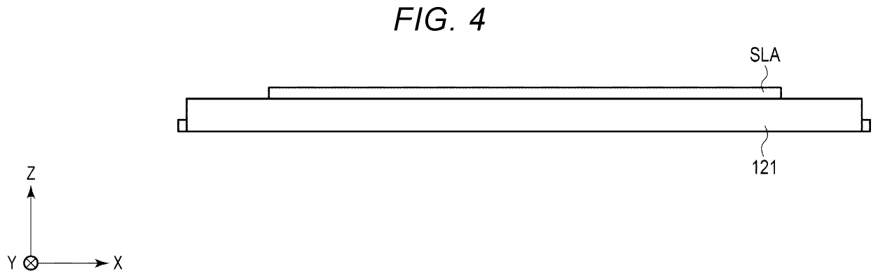

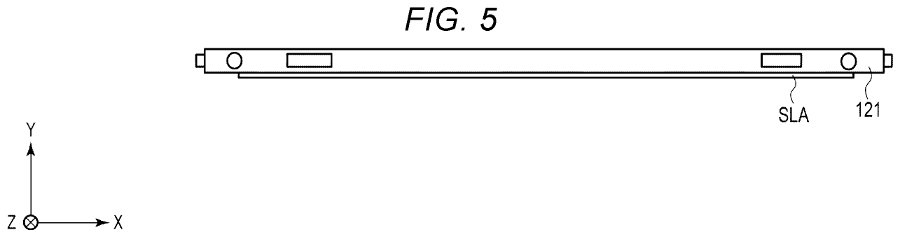

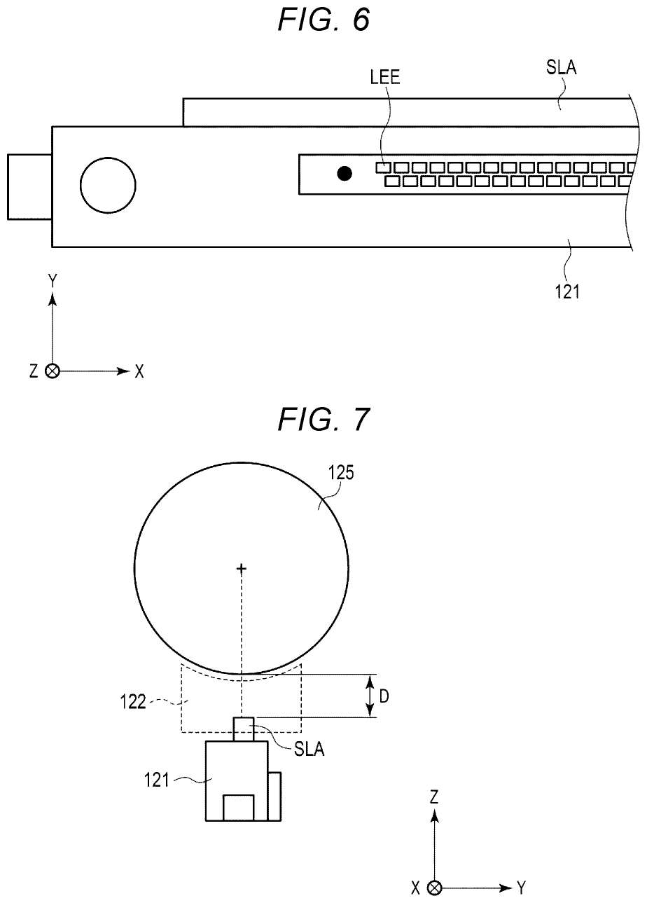

FIG. 3 is a top view illustrating an example of a print head according to at least one embodiment. FIG. 4 is a side view illustrating an example of the print head according to at least one embodiment. FIG. 5 is a bottom view illustrating an example of the print head according to at least one embodiment. FIG. 6 is an enlarged view illustrating an example of a part of the print head according to at least one embodiment.

As illustrated in FIGS. 3 to 5, the print head 121 includes a stretched lens array SLA. As illustrated in FIG. 6, the print head 121 includes a plurality of light emitting elements LEE. The plurality of light emitting elements LEE form one or more light emitting element rows. The stretched lens array SLA collects light from the light emitting elements LEE of the light emitting element row on the photoconductor 125. Accordingly, an image line corresponding to the light emission of the light emitting elements LEE is formed on the photoconductor 125.

The light emitting elements LEE are arranged in a row linearly in a main scanning direction. Alternatively, a first light emitting element row may be formed linearly along the main scanning direction in an arrangement of odd-numbered light emitting elements LEE, and a second light emitting element row may be formed linearly along the main scanning direction in an arrangement of even-numbered light emitting elements LEE. That is, the light emitting elements LEE may be arranged in a staggered manner. In this case, the first light emitting element row and the second light emitting element row are separated from each other by a predetermined length in a sub scanning direction. By controlling light emission timings of the first and second light emitting element rows based on a rotation speed of the photoconductor 125 and the predetermined length, one linear image can be formed by the light emission of the first and second light emitting element rows.

FIG. 7 is a side view illustrating a positional relation between the print head and a photoconductor according to the embodiment.

As illustrated in FIG. 7, the print head 121 faces the photoconductor 125. The image forming device 100 includes a spacer 122, and the spacer 122 keeps a distance (D) between the print head 121 (stretched lens array SLA) and the photoconductor 125 (surface) constant. However, the distance may change due to an influence of deterioration over time. The correction data interface 150 selects the predetermined light amount correction data set from a plurality of light amount correction data sets to reduce an influence of the distance change, and transfers the predetermined light amount correction data set to the print head 121. The print head 121 stores the predetermined light amount correction data set, and causes the light emitting element LEE to emit light based on the stored predetermined light amount correction data set.

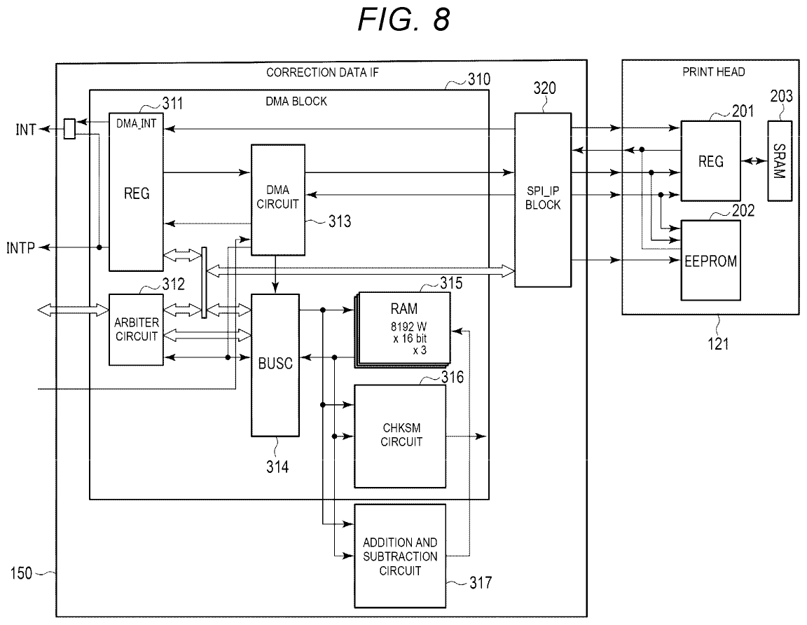

FIG. 8 is a diagram illustrating an example of the print head and a correction data interface unit according to the embodiment.

The print head 121 includes a register (REG) 201 (second memory), EEPROM 202 (first memory), SRAM 203, and the like. The register 201 may be a memory (SRAM) or a flip-flop. Storage of data in the register 201, which will be described later, may be read as registration of data. The EEPROM 202 is a non-transitory computer-readable storage medium that stores the print head information PHDI. The print head information PHDI includes a light amount correction data set for 15400 pixels (8 bits) of the print head 121, and one or more light amount correction difference data sets. For example, the print head information PHDI includes a light amount correction data set Sa (first light amount correction data set), a light amount correction difference data set DSb (first difference data set), and a light amount correction difference data set DSc (second difference data set). Further, the print head information PHDI includes a data checksum CSMa, a data checksum CSMb, and a data checksum CSMc.

The light amount correction data set Sa is a data set for causing the plurality of light emitting elements LEE to emit light with a first light amount, and includes a light amount correction value for each light emitting element LEE. The light amount correction difference data set DSb is a data set showing a difference between a light amount correction data set Sb (second light amount correction data set) for causing the plurality of light emitting elements LEE to emit light with a second light amount and the light amount correction data set Sa, and includes a light amount difference value for each light emitting element LEE. Similar to the light amount correction data set Sa, the light amount correction data set Sb includes a light amount correction value for each light emitting element LEE. The light amount correction difference data set DSc is a data set showing a difference between a light amount correction data set Sc (third light amount correction data set) for causing the plurality of light emitting elements LEE to emit light with a third light amount and the light amount correction data set Sa, and includes a light amount difference value for each light emitting element LEE. Similar to the light amount correction data set Sa, the light amount correction data set Sc includes a light amount correction value for each light emitting element LEE. For example, it is assumed that the second light amount has a larger light amount than the first light amount, and the third light amount has a smaller light amount than the first light amount.

The data checksum CSMa is a first check data for checking an error in the light amount correction data set Sa. The data checksum CSMb is a second check data for checking an error in the light amount correction difference data set DSb. The data checksum CSMc is a third check data for checking an error in the light amount correction difference data set DSc.

The correction data interface 150 includes a direct memory access (DMA) block 310, a serial peripheral interface (SPI) IP block 320, and an addition and subtraction circuit 317. The DMA block 310 includes a register (REG) 311, an arbiter circuit 312, a DMA circuit 313, a bus controller (BUSC) 314, a RAM 315 (third memory), and a data checksum (CHKSM) circuit 316.

The DMA block 310 reads the print head information PHDI from the EEPROM 202, stores the print head information PHDI in the RAM 315, reads a part of the print head information PHDI stored in the RAM 315, and writes back a read part to the SRAM 203 of the print head 121. When the print head information PHDI includes the light amount correction data set Sa, the light amount correction difference data set DSb, and the light amount correction difference data set DSc, the DMA block 310 may include three RAMS corresponding to these three data sets. When the three RAMS are applied, for example, the first RAM stores the light amount correction data set Sa. The second RAM stores the light amount correction difference data set DSb or the light amount correction difference data set DSc. The third RAM stores calculation results of the first and second RAMS. When the three RAMS are not applied, the RAM 136 or the like, which is a memory area for calculation outside the correction data interface 150, plays roles of the above three RAMS.

The arbiter circuit 312 arbitrates a usage right of a bus inside the DMA block 310 and the SPI_IP block 320 based on a signal from the light emitting controller 143. The SPI_IP block 320 functions as an input and output interface, inputs the print head information PHDI read from the EEPROM 202, and outputs the print head information PHDI to the register 311 and the DMA circuit 313 with permission of the bus usage right. The register 311 stores the print head information PHDI. The DMA circuit 313, via the bus controller 314, transfers the light amount correction data set Sa in the print head information PHDI to the RAM 315 and the addition and subtraction circuit 317, and transfers the data checksum CSMa in the print head information PHDI to the data checksum circuit 316. The data checksum circuit 316 checks the light amount correction data set Sa based on the data checksum CSMa, and outputs a check result.

The DMA circuit 313, via the bus controller 314, transfers the light amount correction difference data set DSb in the print head information PHDI to the addition and subtraction circuit 317, and transfers the data checksum CSMb in the print head information PHDI to the data checksum circuit 316. The data checksum circuit 316 checks the light amount correction difference data set DSb based on the data checksum CSMb, and outputs a check result. The addition and subtraction circuit 317 functions as a generation circuit, generates the light amount correction data set Sb based on the light amount correction data set Sa and the light amount correction difference data set DSb, and outputs the light amount correction data set Sb.

The DMA circuit 313, via the bus controller 314, transfers the light amount correction difference data set DSc in the print head information PHDI to the addition and subtraction circuit 317, and transfers the data checksum CSMc in the print head information PHDI to the data checksum circuit 316. The data checksum circuit 316 checks the light amount correction difference data set DSc based on the data checksum CSMc, and outputs a check result. The addition and subtraction circuit 317 functions as a generation circuit, generates the light amount correction data set Sc based on the light amount correction data set Sa and the light amount correction difference data set DSc, and outputs the light amount correction data set Sc.

The RAM 315 stores the output light amount correction data set Sa, the light amount correction data set Sb, and the light amount correction data set Sc.

The DMA circuit 313 transfers the light amount correction data set Sa stored in the RAM 315 to the SPI_IP block 320 via the bus controller 314. Alternatively, the DMA circuit 313 transfers the light amount correction data set Sb stored in the RAM 315 to the SPI_IP block 320 via the bus controller 314. Alternatively, the DMA circuit 313 transfers the light amount correction data set Sc stored in the RAM 315 to the SPI_IP block 320 via the bus controller 314.

The SPI_IP block 320 functions as an input and output interface and outputs the light amount correction data set Sa transferred by the DMA circuit 313 to the register 201. Alternatively, the SPI_IP block 320 outputs the light amount correction data set Sb transferred by the DMA circuit 313 to the register 201. Alternatively, the SPI_IP block 320 outputs the light amount correction data set Sc transferred by the DMA circuit 313 to the register 201.

The register 201 stores the light amount correction data set Sa, the light amount correction data set Sb, or the light amount correction data set Sc output from the SPI_IP block 320. The SRAM 203 stores the light amount correction data set Sa, the light amount correction data set Sb, or the light amount correction data set Sc stored in the register 201. The light emitting element LEE emits light based on the light amount correction data set Sa, the light amount correction data set Sb, or the light amount correction data set Sc.

Although the case of the image forming device 100 in which the addition and subtraction circuit 317 functions as a generation circuit is described, a processor of the light emitting controller 143 or the controller 134 may function as the generation circuit instead of the addition and subtraction circuit 317. The light emitting controller 143 or the controller 134 (processor) acquires the light amount correction data set Sa and the light amount correction difference data set DSb, generates the light amount correction data set Sb based on the light amount correction data set Sa and the light amount correction difference data set DSb, and outputs the light amount correction data set Sb. The light emitting controller 143 or the controller 134 (processor) acquires the light amount correction data set Sa and the light amount correction difference data set DSc, generates the light amount correction data set Sc based on the light amount correction data set Sa and the light amount correction difference data set DSc, and outputs the light amount correction data set Sc.

The image forming device 100 may apply the RAM 136 instead of the RAM 315.

The image forming device 100 may uniformly increase or decrease a light amount of the plurality of light emitting elements LEE based on the light amount correction data set Sa, the light amount correction data set Sb, or the light amount correction data set Sc. Alternatively, the image forming device 100 may selectively apply a light amount correction value in the light amount correction data set Sa, a light amount correction value in the light amount correction data set Sb, or a light amount correction value in the light amount correction data set Sc to each light emitting element LEE and selectively increase or decrease the light amount of each light emitting element LEE. That is, an increase and a decrease in the light amount may be mixed to increase the light amount for a part of the plurality of light emitting elements LEE and decrease the light amount for a part of the plurality of light emitting elements LEE. Further, the plurality of light emitting elements LEE may include a light emitting element LEE that does not correct a light amount.

When the increase and the decrease in the light amount are mixed, for example, the correction data interface 150 selects, for each light emitting element LEE, a light amount correction value in the light amount correction data set Sa, a light amount correction value in the light amount correction data set Sb generated based on the light amount correction data set Sa and the light amount correction difference data set DSb, or a light amount correction value in the light amount correction data set Sc generated based on the light amount correction data set Sa and the light amount correction difference data set DSc, and outputs the light amount correction value selected for each light emitting element LEE. The register 201 of the print head 121 stores the light amount correction value (value to increase the light amount or value to decrease the light amount) selected for each light emitting element LEE, and the SRAM 203 stores the light amount correction value stored in the register 201. Each light emitting element LEE emits light based on the light amount correction values stored in the register 201.

For example, the image forming device 100 reduces light amounts of the light emitting element LEE at locations corresponding to a streak and a blur in the main scanning direction while increasing the light amount of most of the light emitting elements LEE, or conversely, increases a light amount of a part of the light emitting elements LEE while reducing a light amount of most of the light emitting elements LEE. In this way, the image forming device 100 achieves an improvement in image quality by combining the increase and the decrease of the light amount for each light emitting element LEE.

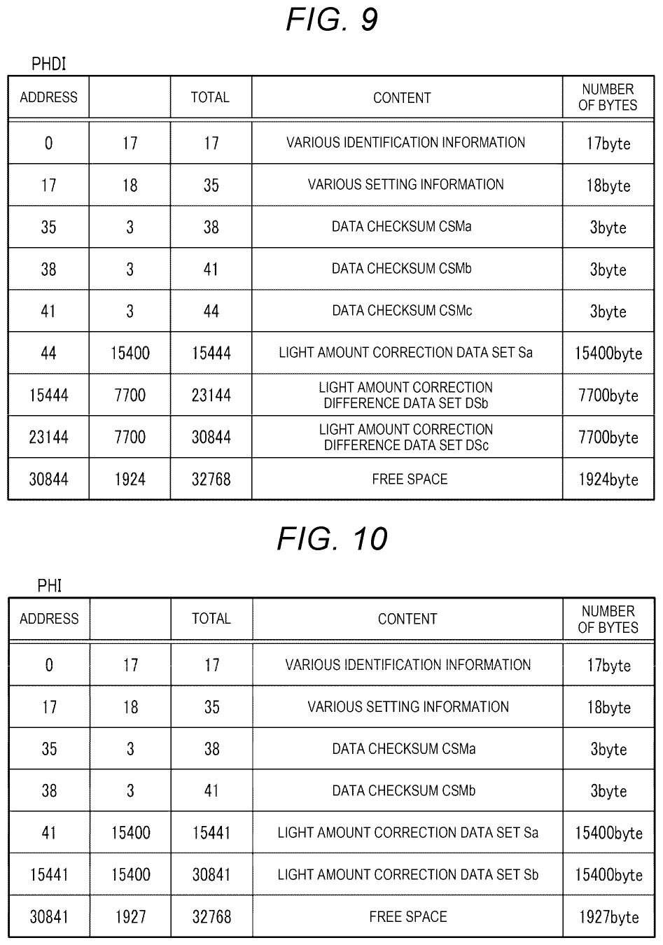

FIG. 9 is a diagram illustrating an example of the print head information PHDI stored in the print head according to the embodiment. The print head information PHDI is data that can be stored in a storage area of 32 Kbytes.

For example, the print head information PHDI includes various identification information (17 bytes), various setting information (18 bytes), the data checksum CSMa (3 bytes), and the data checksum CSMb (3 bytes), the data checksum CSMc (3 bytes), the light amount correction data set Sa (15400 bytes), the light amount correction difference data set DSb (7700 bytes), the light amount correction difference data set DSc (7700 bytes), and a free space (1924 bytes).

The EEPROM 202 stores the various identification information in 17 bytes of addresses 0 to 16, the various setting information (18 bytes) in 18 bytes of addresses 17 to 34, the data checksum CSMa (3 bytes) in 3 bytes (a predetermined number of bytes) of addresses 35 to 37 (third storage area), the data checksum CSMb (3 bytes) in 3 bytes (predetermined number of bytes) of addresses 38 to 40 (fourth storage area), the data checksum CSMc (3 bytes) in 3 bytes (predetermined number of bytes) of addresses 41 to 43, the light amount correction data set Sa (15400 bytes) in 15400 bytes (first number of bytes) at addresses 44 to 15443 (first storage area), the light amount correction difference data set DSb (7700 bytes) in 7700 bytes (second number of bytes) of addresses 15444 to 23143 (second storage area), and the light amount correction difference data set DSc (7700 bytes) in 7700 bytes of addresses 23144 to 30843, and sets 17 bytes after the address 30844 as the free space (1924 bytes).

The various identification information is identification information related to the print head. The various setting information is information related to a mode setting of a light amount correction. The data checksum CSMa is check data for checking an error in the light amount correction data set Sa. The data checksum CSMb is check data for checking an error in the light amount correction difference data set DSb. The data checksum CSMc is check data for checking an error in the light amount correction difference data set DSc.

The light amount correction data set Sa is the data set for causing the plurality of light emitting elements LEE to emit light with the first light amount. The light amount correction difference data set DSb is the data set showing the difference between the light amount correction data set Sb for causing the plurality of light emitting elements LEE to emit light with the second light amount and the light amount correction data set Sa. The light amount correction difference data set DSc is the data set showing the difference between the light amount correction data set Sc for causing the plurality of light emitting elements LEE to emit light with the third light amount and the light amount correction data set Sa.

As mentioned above, compared with the number of bytes of the light amount correction data set Sa, the numbers of bytes of the light amount correction difference data set DSb and the light amount correction difference data set DSc are half, and the numbers of bytes of the data checksums CSMa, CSMb, CSMc are the same. The DMA block 310 checks the errors in the light amount correction data set Sa, the light amount correction difference data set DSb, and the light amount correction difference data set DSc by the same processing based on the data checksums CSMa, CSMb, CSMc that are formed by the predetermined number of bytes.

FIG. 10 is a diagram illustrating an example of print head information PHI.

The print head information PHDI (FIG. 9) described above includes the light amount correction data sets, and includes one or more light amount correction difference data sets to improve efficiency of the light amount correction data. On the other hand, the print head information PHI (FIG. 10) includes the light amount correction data sets and does not include the light amount correction difference data set. The print head information PHDI and the print head information PHI will be described in comparison with reference to FIGS. 9 and 10.

The print head information PHDI and the print head information PHI are both information corresponding to a plurality of light amount modes. As illustrated in FIGS. 9 and 10, it is assumed that the numbers of bytes of the print head information PHDI and the print head information PHI are the same. Assuming that a capacity of the EEPROM 202 of the print head 121 is 32 Kbyte, the print head information PHDI and the print head information PHI can be stored. The print head information PHDI is information that can correspond to more light amount modes than the print head information PHI by including the one or more light amount correction difference data sets.

The print head information PHDI includes the light amount correction data set Sa, the light amount correction difference data set DSb, and the light amount correction difference data set DSc. The light amount correction data set Sa (8 bits) has a difference of 4 bits from the light amount correction difference data set DSb (4 bits) and the light amount correction difference data set DSc (4 bits). Therefore, the print head information PHDI is information that can correspond to first, second, and third light amount modes corresponding to the first, second, and third light amounts, respectively.

On the other hand, the print head information PHI includes the light amount correction data set Sa and the light amount correction data set Sb. A total of the light amount correction data set Sa (8 bits) and the light amount correction data set Sb (8 bits) is 16 bits. Therefore, the print head information PHI is information that can correspond to first and second light amount modes corresponding to the first and second light amounts, respectively.

For example, data for one pixel in the light amount correction data set is 8 bits. A light amount correction data set for the print head 121 with 15400 pixels is 15400 bytes, and a non-volatile memory (EEPROM 202) having a storage capacity of this size or more is required to store the light amount correction data set.

When storing a plurality of light amount correction data sets due to a difference in the distance (D) between the print head 121 and the photoconductor 125 in the non-volatile memory, a storage capacity of 15400 bytes is required each time one data set increases. Focusing on a variation in a data value of each pixel of a reference light amount correction data set, a difference between a maximum value and a minimum value is, for example, 4 bits (16) or less. In such a case, reference data is set as 8 bits full data (absolute value), and light amount correction data that changes depending on the distance (D) is set as 4 bits difference data instead of the 8 bits full data. When applying the difference data, the correction data interface 150 or the like adds the difference data to the reference data, calculates the 8 bits full data, and provides the calculated 8 bits full data to the print head 121. The reference data corresponds to data in the light amount correction data set Sa, and the difference data corresponds to data in the light amount correction difference data sets DSb and DSc. The print head 121 stores, in the non-volatile memory, the print head information PHDI including the difference data instead of the full data. An increase in a storage capacity of the non-volatile memory of the print head 121 can be reduced.

Next, various events caused by a variation of irradiation light on a surface of the photoconductor 125 will be described.

Due to characteristics of the print head 121, the irradiation light to the surface of the photoconductor 125 may vary. That is, just-focused image points at all pixel positions may not be obtained. Accordingly, a resolution (MTF) deterioration portion may occur, and a blurred image may occur at a corresponding portion.

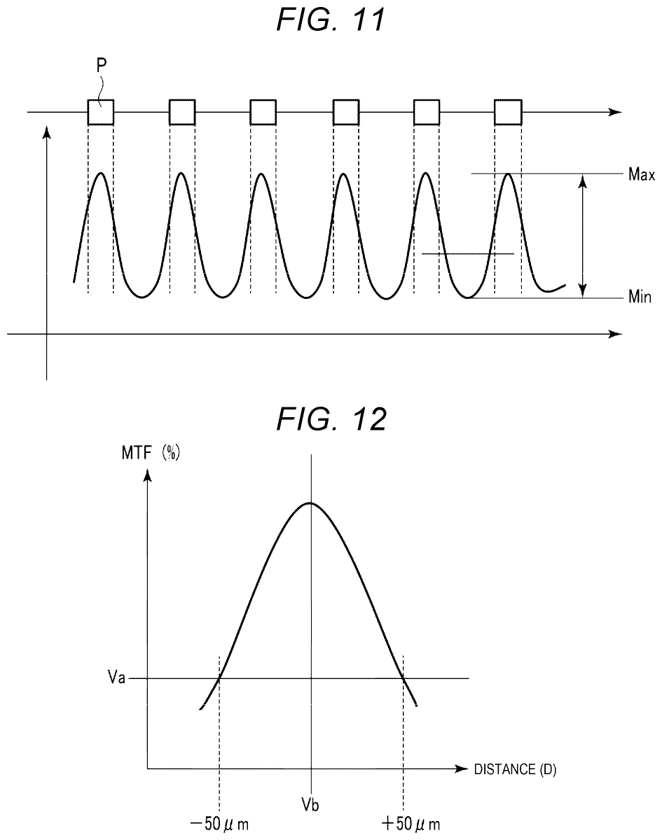

FIG. 11 is a diagram illustrating an outline of the MTF.

For example, when one light emitting element LEE corresponding to one pixel (P) emits light and two light emitting elements LEE corresponding to two pixels do not emit light, luminance (Max) at a location with an emission point and luminance (Min) at a location without the emission point are measured. The MTF is calculated as follows. The larger the MTF, the higher the resolution.

MTF (%)=(((Max)−(Min))/((Max)+(Min)))×100

FIG. 12 is a diagram illustrating a relation between the MTF and the distance (D).

The distance (D) shows the distance between the print head 121 (stretched lens array SLA) and the photoconductor 125 (surface). A vertical axis illustrated in FIG. 11 shows the MTF (%), and a horizontal axis shows the distance (D). The distance (D) is adjusted such that the MTF is equal to or higher than a reference value Va. When the image forming device 100 is shipped, for example, the distance (D) is adjusted according to a design value Vb.

For example, in the state where the distance (D) is adjusted according to the design value Vb, when the light amount correction data set Sa is applied, the MTF is maximum. Considering various situations, when the distance (D) is long and the light amount correction data set Sb is applied, a decrease in the MTF is reduced. When the distance (D) is short and the light amount correction data set Sc is applied, a decrease in the MTF is reduced.

The DMA block 310 generates the light amount correction data set Sb based on the light amount correction data set Sa and the light amount correction difference data set DSb, and generates the light amount correction data set Sc based on the light amount correction data set Sa and the light amount correction difference data set DSc. The DMA block 310 outputs the light amount correction data set Sa, the light amount correction data set Sb, or the light amount correction data set Sc. Since the print head 121 emits light based on the light amount correction data set Sa, the light amount correction data set Sb, or the light amount correction data set Sc, the print head 121 can handle both an event in which the distance is long and an event in which the distance is short.

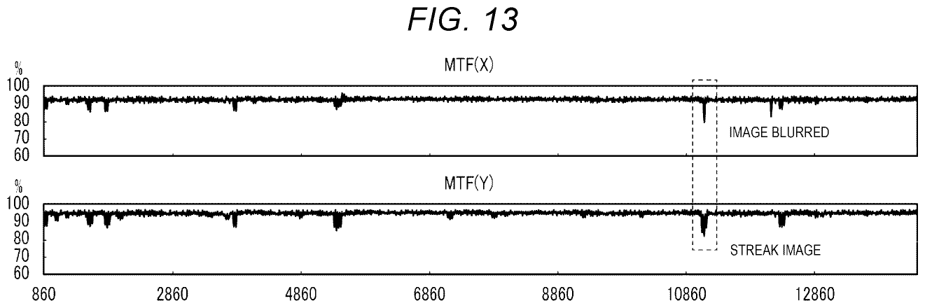

FIG. 13 is a diagram illustrating a relation between the MTF and a streak image.

A MTF (X) shows a resolution in the main scanning direction, and a MTF (Y) shows a resolution in the sub scanning direction. The print head 121 according to the present embodiment includes two rows of staggered light emitting elements LEE, and an influence thereof appears on the MTF (Y). The MTF (X) and the MTF (Y) are linked values. For example, due to factors such as falling of a lens of the SLA as a special factor, light emission luminance may be lower in the sub scanning direction than in the main scanning direction. A place where the MTF decreases is in a state in which an image is blurred (so-called out-of-focus state), and a light emitting range is widened. In light amount correction, correction data is set to keep a light amount (power) in a predetermined range (area) of a measuring device constant. Therefore, the light emitting range is widened in an out-of-focus portion, and in addition to a portion where a light amount in a central portion is the same as that of other pixels, a light amount in a peripheral portion is also presented as it is. Therefore, an energy density obtained by integrating the light amounts in the range is high. When an image such as a halftone is printed, a darkened streak image is observed in a corresponding portion, which is one of factors that deteriorate an image quality. For this reason, when the distance (D) between the print head 121 and the photoconductor 125 changes, the number of places where the resolution (MTF) changes usually increases, and thus the streak image is likely to occur.

The print head 121 according to at least one embodiment stores the print head information PHDI including a difference data set. The print head 121 can support a plurality of light amount modes with a small storage capacity. The image forming device 100 according to the embodiment reads out the print head information PHDI including the difference data from the print head 121, generates light amount correction data set of full data corresponding to a designated light amount mode, and sets, to the print head 121, the light amount correction data set of the full data. The image forming device 100 can support the plurality of light amount modes with a small storage capacity.

While certain embodiments have been described, these embodiments have been presented by way of example only, and are not intended to limit the scope of the disclosure. Indeed, the novel apparatus and methods described herein may be embodied in a variety of other forms; furthermore, various omissions, substitutions and changes in the form of the apparatus and methods described herein may be made without departing from the spirit of the disclosure. The accompanying claims and their equivalents are intended to cover such forms or modifications as would fall within the scope and spirit of the disclosure. cm What is claimed is:

1. A print head comprising:
a first memory configured to store (i) a first light amount correction data set for causing a plurality of light emitting elements to emit light having a first light amount, and (ii) a first difference data set having a difference between the first light amount correction data set and a second light amount correction data set, the second light amount correction data set for causing the plurality of light emitting elements to emit light having a second light amount; and
a second memory configured to store (a) the first light amount correction data set, or (b) the second light amount correction data set, the second light amount correction data set obtained from the first light amount correction data set and the first difference data set,
wherein the plurality of light emitting elements are configured to emit light based on the first or second light amount correction data set stored in the second memory.

2. The head according to claim 1, wherein
a correction data interface is configured to read the first light amount correction data set and the first difference data set from the first memory, and to output the first or second light amount correction data set, and
wherein the second memory is configured to store the first or second light amount correction data set output from the correction data interface.

3. The head according to claim 1, wherein
the first memory includes a first storage area having a first number of bytes configured to store the first light amount correction data set, and a second storage area having a second number of bytes configured to store the first difference data set, and
wherein the second number of bytes is less than the first number of bytes.

4. The head according to claim 3, wherein
the first memory includes a third storage area and a fourth storage area, the third storage area having a predetermined number of bytes configured to store first check data for checking the first light amount correction data set, the fourth storage area having a predetermined number of bytes configured to store second check data for checking the first difference data set.

5. The head according to claim 1, wherein
the second light amount is greater than the first light amount,
the first memory is further configured to store: a second difference data set having a difference between a third light amount correction data set and the first light amount correction data set, the third light amount correction data set for emitting light with a third light amount smaller than the first light amount,
the second memory is configured to store, for each light emitting element, a first light amount correction value in the first light amount correction data set, a second light amount correction value in the second light amount correction data set, or a third light amount correction value in the third light amount correction data set obtained from the first light amount correction data set and the second difference data set, and
each light emitting element is configured to emit light based on the first, second, or third light amount correction value stored in the second memory.

6. An image forming device comprising:
a print head; and
a correction data interface, wherein
the print head comprises:
a first memory configured to store (i) a first light amount correction data set for causing a plurality of light emitting elements to emit light having a first light amount, and (ii) a first difference data set having a difference between a second light amount correction data set and the first light amount correction data set, the second light amount correction data set for causing the plurality of light emitting elements to emit light having a second light amount,
a second memory configured to store the first light amount correction data set, or the second light amount correction data set, the second light amount correction data set being obtained from the first light amount correction data set, and the first difference data set, and
wherein the plurality of light emitting elements are configured to emit light based on the first or second light amount correction data set stored in the second memory,
wherein the correction data interface comprises:
an input and output interface configured to input the first light amount correction data set and the first difference data set from the first memory, and to output the first or second light amount correction data set, and
a generation circuit configured to generate the second light amount correction data set based on the first light amount correction data set and the first difference data set, and
the second memory is configured to store the first or second light amount correction data set output from the correction data interface.

7. The device according to claim 6, wherein
the correction data interface comprises a third memory configured to store the first light amount correction data set and the first difference data set read from the first memory.

8. The device according to claim 7, wherein
the generation circuit is configured to generate the second light amount correction data set based on the first light amount correction data set and the first difference data set output from the third memory.

9. The device according to claim 7, wherein
each of the first and third memories comprises: a first storage area having a first number of bytes configured to store the first light amount correction data set, and a second storage area having a second number of bytes configured to store the first difference data set, and
the second number of bytes is less than the first number of bytes.

10. The device according to claim 9, wherein
each of the first and third memories comprises a third storage area and a fourth storage area, the third storage area having a predetermined number of bytes configured to store first check data for checking the first light amount correction data set, the fourth storage area having a predetermined number of bytes configured to store second check data for checking the first difference data set.

11. The head according to claim 1, wherein the plurality of light emitting elements include at least one of light emitting diodes or organic light emitting diodes.

12. The device according to claim 6, further including a plurality of print heads.

13. The device according to claim 6, further including a light emitting controller configured to control the plurality of light emitting elements based on the first or second light amount correction data set.

14. The device according to claim 13, wherein the light emitting controller is configured to control the plurality of light emitting elements to uniformly increase or decrease the light amount of the plurality of light emitting elements.

15. The device according to claim 13, wherein the light emitting controller is configured to control the plurality of light emitting elements to selectively increase or decrease the light amount of the plurality of light emitting elements.

16. A method of operating a print head comprising:
storing in a first memory, (i) a first light amount correction data set for causing a plurality of light emitting elements to emit light having a first light amount, and (ii) a first difference data set having a difference between a second light amount correction data set and the first light amount correction data set, the second light amount correction data set for causing the plurality of light emitting elements to emit light having a second light amount;
storing in a second memory, the first light amount correction data set, or the second light amount correction data set obtained from the first light amount correction data set and the first difference data set; and
emitting light from the plurality of light emitting elements based on the first or second light amount correction data set stored in the second memory.

17. The method according to claim 16, further comprising:
reading the first light amount correction data set and the first difference data set from the first memory;
outputting the first or second light amount correction data set; and
storing in the second memory, the first or second light amount correction data set output.

18. The method according to claim 16, further comprising:
storing the first light amount correction data set in a first storage area of the first memory, the first storage area having a first number of bytes; and
storing the first difference data set in a second storage area having a second number of bytes, and
wherein the second number of bytes is less than the first number of bytes.

19. The method according to claim 18, further comprising:
storing first check data having a predetermined number of bytes for checking the first light amount correction data set in a third storage area of the first memory; and
storing second check data having the predetermined number of bytes for checking the first difference data set in a fourth storage area of the first memory.
